(19) United States
(12) Patent Application Publication
(10) Pub. No.: US 2013/0303353 A1
(43) Pub. Date: Nov. 14, 2013

(54) Thin Sealing Device For Side Sealing Machine

(71) Applicant: SEALED AIR CORPORATION (US), Elmwood Park, NJ (US)

(72) Inventors: Thomas Orsini, III, Sterling, MA (US); Russell Christman, Dunstable, MA (US); Todd Brown, Arlington, MA (US)

(21) Appl. No.: 13/796,428

(22) Filed: Mar. 12, 2013

Related U.S. Application Data
(60) Provisional application No. 61/646,503, filed on May 14, 2012.
(60) Provisional application No. 61/697,684, filed on Sep. 6, 2012.

(51) Int. Cl. B31B 37/00

(52) U.S. Cl. CPC B31B 37/00
USPC 493/189

(57) ABSTRACT

A thin sealing device which is resistant to damage caused by foreign material is disclosed. The thin sealing device has an internal heating element. The thin sealing device has a blunt edge, which has a radius smaller than that of the heating element. A thermocouple is placed in a cavity near this blunt edge to monitor the temperature at the point of sealing. In some embodiments, the thin sealing device is pivotably attached at its leading (upstream) edge. The trailing (downstream) edge of the thin sealing device is moved by means of a compressible force, such as an air cylinder. In this way, the air in the cylinder pushes the thin sealing device downward into the plane of the film. However, a foreign object located on the film can overcome the force of the air cylinder, thereby lifting the thin sealing device out of the path of the film.

This application claims priority of U.S. Provisional Application Ser. No. 61/646,503 filed May 14, 2012 and U.S. Provisional Application Ser. No. 61/697,684 filed Sep. 6, 2012, the disclosures of which are incorporated herein by reference.

### BACKGROUND OF THE INVENTION

Machines used to wrap and seal articles and packages in thermoplastic film are well known in the art. Two types of machines are commonly referred to as side-sealing and lap-sealing machines. In the typical side-sealing configuration, an article or set of articles travels, typically via a conveyer belt, toward the machine. A sheet of center-folded plastic film, having two layers, is fed from a direction, which is preferably perpendicular to the direction of the conveyer. The two layers of the film are then separated such that the article is placed between the lower layer and the upper layer. On one side of the article is the center-fold, while on the other side, there is an open edge where the two layers are not attached. The machine has several sets of belts to hold and guide the film, and a side sealing mechanism, which typically comprises a heating/sealing element that fuses or welds the two layers together and a cutting element that removes the excess material. In some embodiments, the heating element serves to cut the film as well. These elements, whether a unitary element or separate components, are referred to as the heating/sealing/cutting element throughout this disclosure. Thus, as the article passes by the side sealing mechanism, this open edge is sealed by welding the two layers together, the plastic is cut and the waste is removed and discarded. At this point, the plastic film resembles a tube, with openings at both the leading and trailing ends of the article, but sealed along both sides. As the article continues to advance, an end sealing mechanism is then employed to seal the film at the leading end of the article. The article is then advanced and the end sealing mechanism then seals the film at the trailing end of the article.

Incomplete, inconsistent or sloppy welds can be problematic with these types of machines. The choice of heating/sealing/cutting element, film thickness and film speed are all factors in determining the quality of the seal. It is possible that different types of side sealing mechanisms may optimize seals for certain configurations. For example, tubular heating elements may optimize seals for high speed and/or thick films, while heated cutting blades may optimize lower speed and/or thinner films.

One potential issue associated with side sealing units is clogging or jamming. Material, such as excess film or foreign objects may be drawn into the side sealing mechanism. For heated cutting blades, the size and shape of the device is such that the material does not cause damage to the heating element. However, tubular heating elements are much smaller, and thus are prone to damage in this scenario.

Therefore, a thin sealing device which is more resistant to damage caused by foreign material drawn into the side sealing mechanism would be beneficial.

### SUMMARY OF THE INVENTION

The problems associated with the prior art have been overcome by the present invention, which describes a thin sealing device that is resistant to damage caused by foreign material. The thin sealing device has an internal heating element. The thin sealing device has a blunt edge, which has a radius smaller than that of the heating element. A thermocouple is placed near this blunt edge to monitor the temperature at the point of sealing. In some embodiments, the thin sealing device is pivotably attached to the side sealing machine at its leading (upstream) edge. The trailing (downstream) edge of the thin sealing device is moved by means of a compressible force, such as an air cylinder. In this way, the air in the cylinder pushes the thin sealing device downward into the plane of the film. However, a foreign object located on the film can overcome the force of the air cylinder, thereby lifting the thin sealing device out of the path of the film.

### BRIEF DESCRIPTION OF THE DRAWINGS

FIG. 1 illustrates a representative side-sealing machine of the prior art;

FIG. 2 illustrates a view of the side-sealing mechanism in accordance with the present invention;

FIG. 3 illustrates a top view of the side-sealing mechanism shown in FIG. 2;

FIGS. 4A-C illustrate the shape of the thin sealing device;

FIG. 5 illustrates a universal side mechanism;

FIG. 6 shows a front view of the thin sealing device in the stowed position;

FIG. 7 shows a front view of the thin sealing device in an operative position;

FIGS. 8A-8C illustrate the relationship of the thin sealing device to the film when in various positions;

FIGS. 9A-9B illustrate how the thin sealing device responds to a foreign material in its path;

FIG. 10 shows another embodiment of the thin sealing device;

FIG. 11 illustrates the shape of a thin sealing device according to another embodiment;

FIGS. 12A-B illustrate the shape of the thin sealing device according to another embodiment;

FIG. 13 illustrates the shape of a thin sealing device according to another embodiment; and

FIG. 14 illustrates the shape of a thin sealing device according to another embodiment.

### DETAILED DESCRIPTION OF THE INVENTION

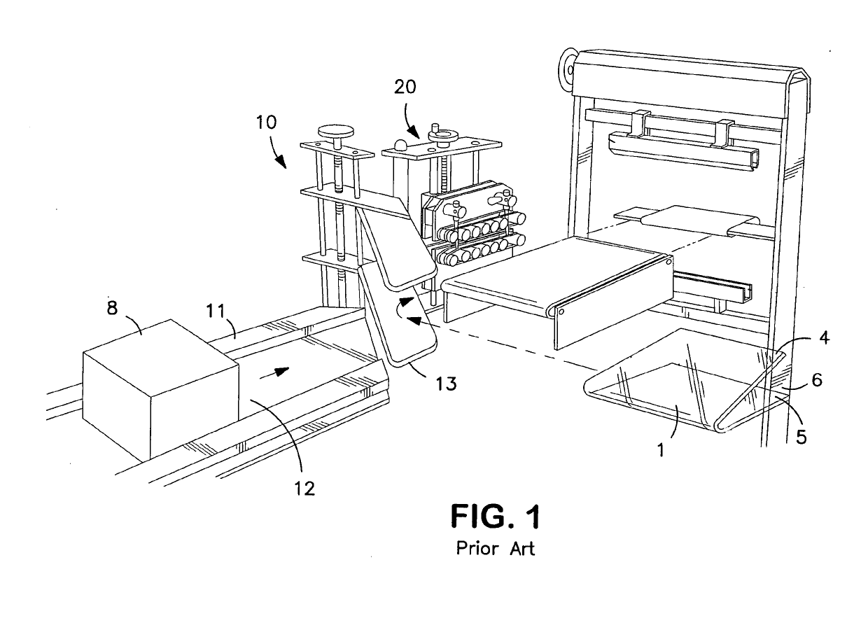

FIG. 1 illustrates a representative side-sealing machine used to encapsulate or wrap an article in thermoplastic film, as described in U.S. Pat. No. 6,526,728. The machine 10 utilizes a conveyer belt 12 operating at a relatively constant speed to deliver articles 8 that are to be encapsulated. The thermoplastic film 1 is center-folded, such that the side with the fold is closed, while the opposite side 6 is open. On this opposite side, there are two layers of film 4,5, which will later be sealed. This center-folded thermoplastic film 1 is fed from a reel (not shown) that is preferably mounted such that the film is fed perpendicular to the direction of travel of the conveyer belt 12. The film is then inverted and separated by an inverter 13 such that the article is enveloped between the two layers 4,5. At this point, the film 1 on one side of the article is closed, while the opposite side 6 remains open. Also, the film at both the leading and trailing ends of the article are not sealed. Downstream from the inverter is the side-sealing mechanism 20. After proper relative positioning of the article between the layers of the film 4,5, the enveloped article approaches the side-sealing mechanism 20.

The side-sealing mechanism 20 is located on the open side 6 of the enveloped article. The mechanism holds the two layers of film 4,5 together, and guides the layers through the heating and cutting means. It then welds the two layers together, and cuts off the surplus material. The surplus material is pulled away so as not to reattach to the film while it is still at an elevated temperature.

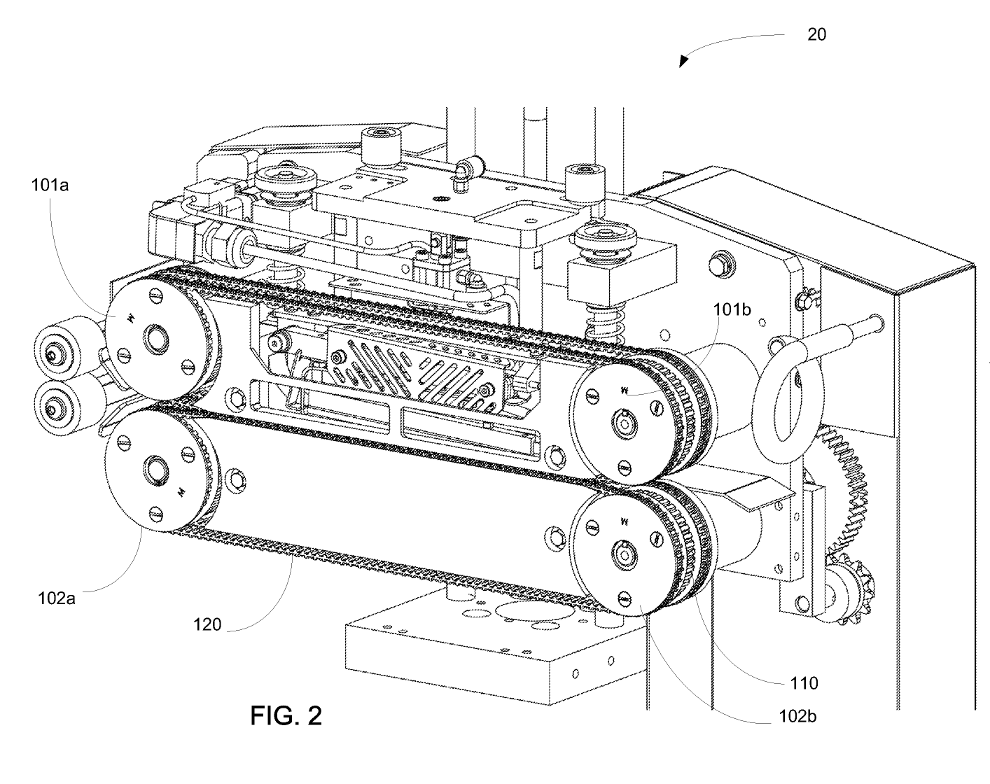

As shown in FIG. 2, to perform these actions, the mechanism 20 preferably comprises two sets of cooperating pulleys, an upper set 101 and a lower set 102. These sets work in unison to pull the two layers of film into the mechanism and hold the layers in place. In the preferred embodiment, each of the pulleys has teeth 110 in its channel so as to accept one or more, preferably two, timing belts 120. The presence of teeth 110 ensures that the timing belt does not slip relative to the pulleys. However, V belts can also be utilized with this invention, as well. The first set of pulleys 101 is located above the layers of film, while the second set 102 is located below the layers. Each set comprises a drive pulley 101a, 102a and a tail pulley 101b, 102b. There may optionally be one or more idler pulleys (not shown). Each of these pulleys also has one or more, preferably two, O-rings mounted in the channel where the belts are located, so as to provide individual channels for each of the timing belts.

Each of the timing belts preferably has a special gripping outer surface, that is bonded to a truly endless steel or Kevlar reinforced timing belt. Each corresponding set of belts has upper and lower pressure plates that are preset to insure good contact between the pair of belts.

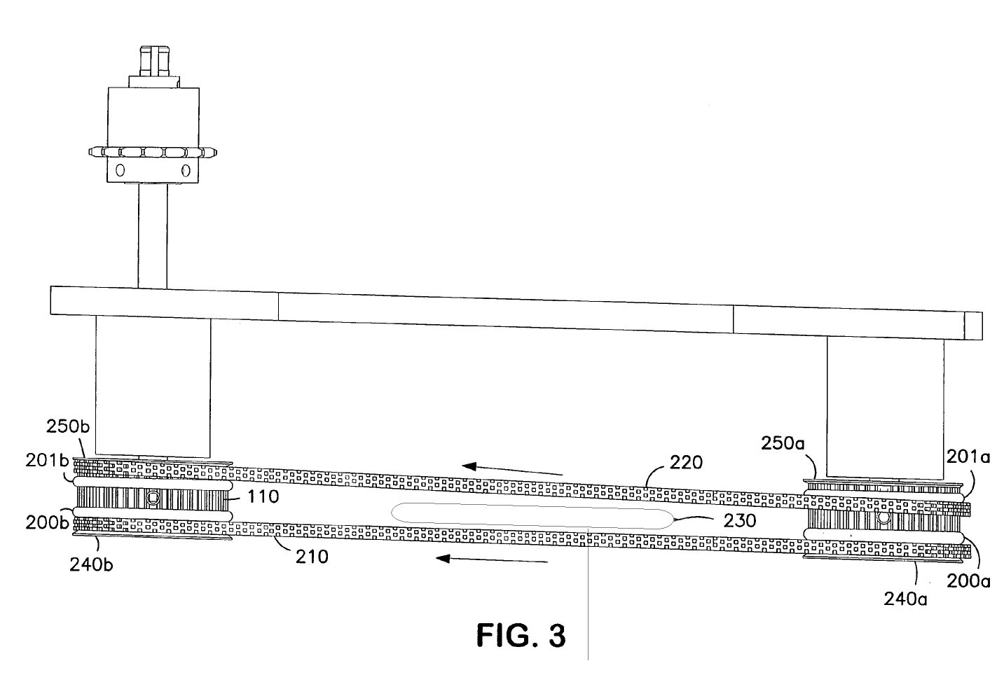

In one embodiment, as shown in FIG. 3, one set of O-rings 200 is positioned such that the movement of the outermost belt 210 is made to be parallel to the direction of the film movement. The outer wall of the pulley 240 and this first set of O-rings 200 provide the guides for the outermost belt 210. As shown in FIG. 3, O-ring 200a and O-ring 200b are equidistant from the outer wall of their respective pulleys. A second set of O-rings 201 is used to guide the innermost belt 220 in a path that diverges away from the direction of the film and the outermost belt. This can be accomplished in a number of ways. For example, a combination of one O-ring and the inner wall of the downstream pulley 250b can be used to define the channel for the innermost belt 220, as shown in FIG. 3. Similarly, two O-rings may be inserted on the upstream pulley to define a channel for the innermost belt. Alternatively, a single O-ring 201a, as shown in FIG. 3, can be used to define the inner wall of the channel for the innermost belt 220. Because of the divergence angle, there are no forces pushing the innermost belt 220 toward the outermost belt 210, thus the second O-ring may be eliminated. In other words, in the channel associated with the upstream pulley 240a, the O-ring 201a provides the inner guide for the belt 220. In the channel associated with the downstream pulley 240b, the O-ring 201b provides the outer guide for the belt 220. As a result, the innermost belt 220 is closest to the outermost belt 210 at the upstream pulley, and farthest away from it at the downstream pulley. The thin sealing device 230 is preferably located between the upstream and downstream pulleys. Thus, as the film passes the upstream pulley, it is still intact; however, it is cut before it reaches the downstream pulley. By introducing this divergence angle, the innermost belt 220 helps guide the unwanted surplus away from the film after it is cut. In the preferred embodiment, the innermost belt 220 is guided in the channel of the downstream pulley a distance further away from the film than on the upstream pulley sufficient to force the surplus plastic away from the film. One such suitable distance is about ¼ inch. This ensures that the surplus material does not reattach itself to the film while still at an elevated temperature. This surplus material is then held under tension and fed into a reel, which is later discarded. While the use of multiple belts, with a divergence between them is preferred, the use of a single belt, or multiple parallel belts is also within the scope of the present invention.

The side-sealing mechanism 20 includes the thin sealing device 230. As described above, this element 230 is preferably located between the upstream and downstream pulleys, so that it can seal and cut the film before it is separated by the downstream pulley.

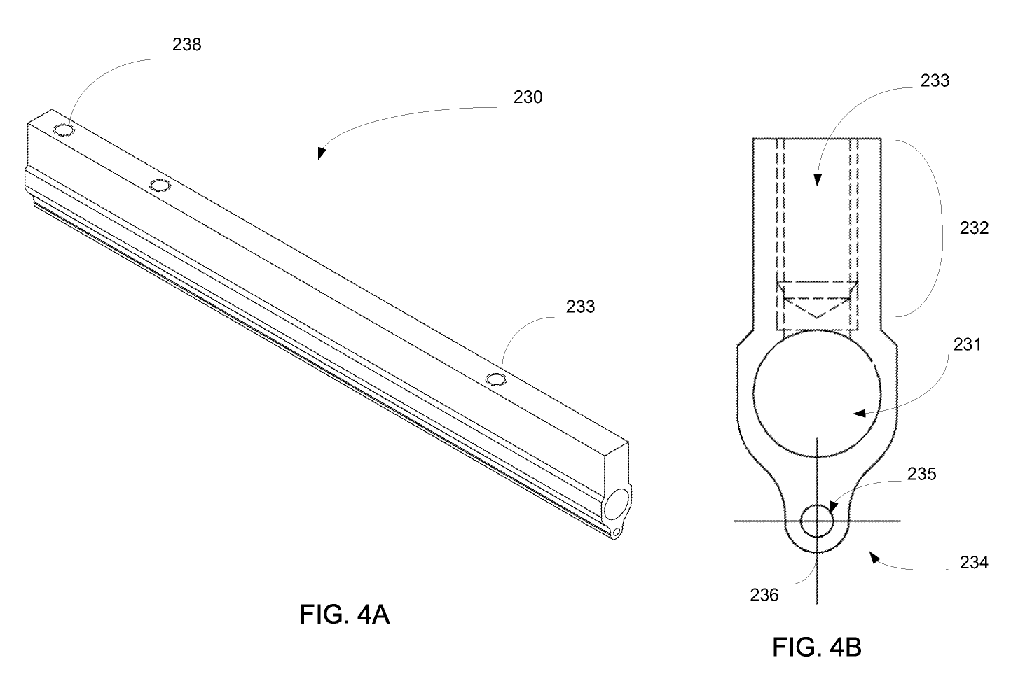

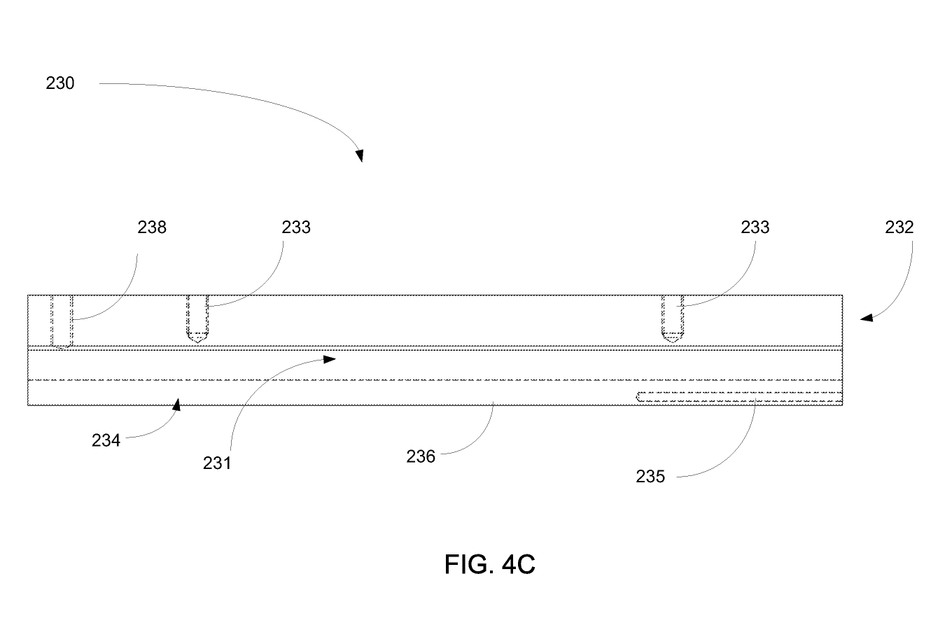

As seen in FIG. 4A, the sealing device 230 is preferably of unitary construction and may be made of a thermal conductive material, such as metal. The sealing device 230 may be about 6 inches long, and about ¼ inch wide. The sealing device 230 may have a height of about ¾ inches or more. Of course, other dimensions may also be used.

As seen in the cross-section view of FIG. 4B, the thin sealing device 230 may include a hollow tube 231, having a circular cross-section into which a heating element (not shown) is inserted. In some embodiments, this hollow tube 231 extends through the entire body of the thin sealing device 230. In other embodiments, the hollow tube 231 extends from one end into the body of the sealing device 230 but does not extend through the distal end. In some embodiments, this hollow tube 231 has a diameter of about ¼ inches, although other dimensions can also be used. The material enveloping the hollow tube 231 may be about 1/16 to 1/32 inches in width. A heating element (not shown) is inserted into the hollow tube 231. This heating element may have one or more electrical connections which supply the power used by the element to generate the requisite heat. As there is little mass on the sides of the hollow tube 231, most of the heat created is radiated upward (away from the film) or downward (toward the cutting edge).

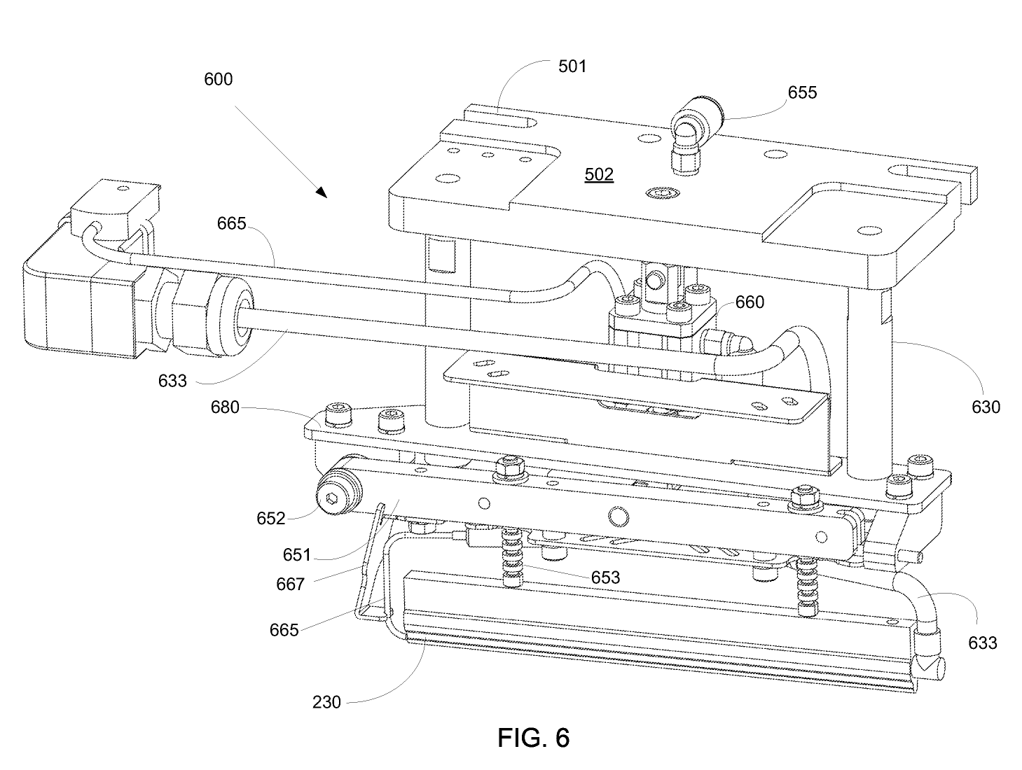

The thin sealing device 230 also may include an upper portion 232, which is located above (i.e. further from the plane of the film than) the hollow tube 231. This upper portion 232 provides structural integrity for the device 230 and also serves as the connection point to the pivotable member from which the thin sealing device 230 is suspended, as described in more detail below. The upper portion 232 may also have one or more openings 233, which may be threaded, into which fasteners 653 (see FIG. 6), such as screws or bolts, can be inserted, which affix the upper portion 232 to the pivotable member 651. While FIG. 4B shows the openings being vertical, the disclosure is not limited to this embodiment. For example, the openings may be horizontal. The upper portion 232 may also have a conduit 238 that passes from the top surface to the hollow tube 231. This conduit 238 may be threaded and used to capture a set screw, which can be used to hold the heating element (not shown) in place. In some embodiments, the upper portion 232 has a width of about ¼ inches, although other dimensions are also possible. In the embodiment shown in FIG. 4B, the width of the upper portion 232 and the diameter of the hollow tube 231 are the same. However, other embodiments are possible where the width of the upper portion 232 may be greater or less than the diameter of the hollow tube 231. The distance from the top of the hollow tube 231 to the top surface of the thin sealing device 230 may be about ⅜ inches, although other dimensions are also possible.

The thin sealing device 230 also has a lower portion 234. The lower portion is below (i.e. closer to the film than) the hollow tube 231. The lower portion 234 contains a blunt edge 236 that contacts the film to heat, seal and cut it. Unlike knife heaters, this blunt edge 236 does not terminate in a point. Rather, the blunt edge 236 may have a radius of about 1/16 inches. This radius limits the amount of heated film that adheres to the tip. In addition, in some embodiments, the blunt edge 236 has a narrower cross-sectional width than the hollow tube 231. In other words, the hollow tube 231 must have a certain minimum diameter in order to fit the heating element therein. By introducing a lower portion 234, it is possible to allow the blunt edge 236 that contacts the film to be narrower, in cross-section, than the heating element and the diameter of the hollow tube 231. This configuration allows the dimension or overall size of the heating element to not impact the dimension of the cutting/sealing edge of the sealing device 230. For example, in the embodiment shown in FIG. 4B, the width of the blunt edge 236 is about ⅛ inches, while the diameter of the hollow tube 231 is ¼ inches. The distance from the bottom of the hollow tube 231 to the bottom of the blunt edge 236 may be about 3/16 inches, although other dimensions can also be used. For example, in some embodiments, the hollow tube 231 may have a diameter equal to or less than the width of the blunt edge 236.

In some embodiments, a cavity 235 is created in one end of the lower portion 234. A thermocouple (not shown) may then be inserted into this cavity 235. This cavity may have a diameter of 1/16 inches, and may extend about 1.5 inches into the lower portion 234. The creation of a separate cavity 235 to hold the thermocouple separate from the heating element allows the thermocouple to more accurately measure the actual temperature of the blunt edge 236. A wire may be connected to the thermocouple and lead to the feedback connector of a universal side mechanism 21. However, in other embodiments, a heating element with an integrated thermocouple may be used. In such a case, a thermocouple may not be located in cavity 235.

The terms “upper” and “lower” are intended to represent the position of each portion relative to the film. In other words, in a configuration where the sealing device is located above the film, the upper portion 232 is that portion which is furthest from the film, which is above the lower portion 236. However, in a configuration where the sealing device is located below the film, the upper portion 232 would remain the portion furthest from the film, which in this embodiment, would actually be below the lower portion 234.

FIG. 4C shows a side view of the thin sealing device 230. As can be seen, the hollow tube 231 (shown with dotted lines) extended from one end of the thin sealing device 230 to the opposite end. Cavity 235 extends from one end only a portion of the way through the sealing device 230. As explained above, a heating element (not shown) is inserted into the hollow tube 231 and serves to heat the entire thin sealing device 230. A thermocouple (not shown) is inserted into the cavity 235. Since this cavity 235 is separate from the hollow tube 231, and is closer to the blunt edge 236, it may represent a more accurate temperature measure.

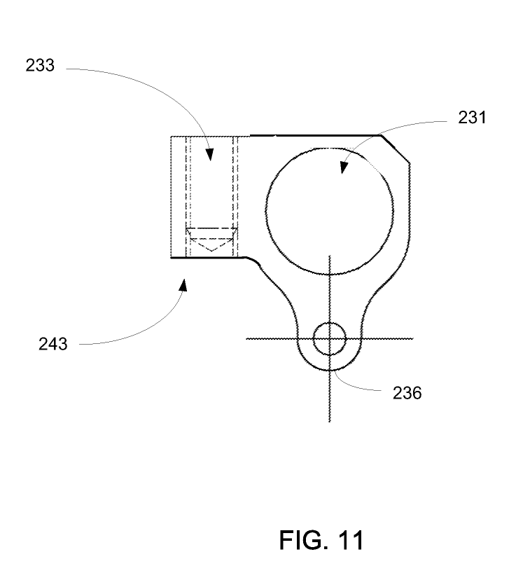

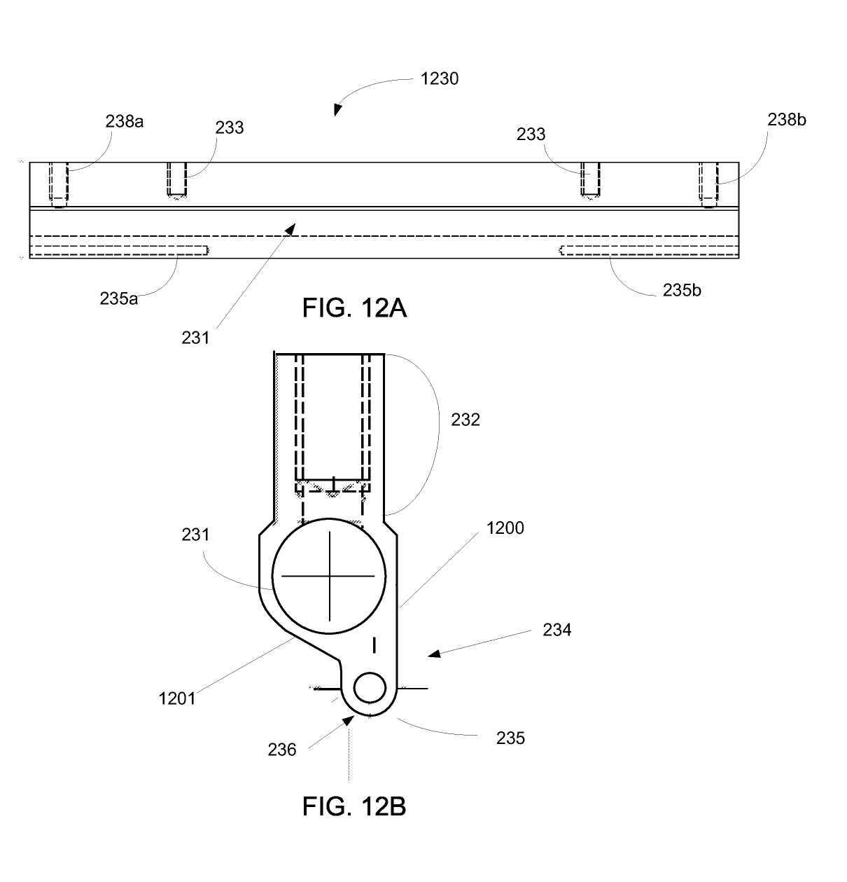

It should be noted that upper portion 232 serves to provide mounting location points as well as extra mass for structural integrity. While FIGS. 4A-C show the mounting locations placed above the hollow tube 231, other embodiments are also possible. For example, rather than having an upper portion, a side portion 243 may be placed adjacent to the hollow tube 231, as shown in FIG. 11. This side portion 243 may have the openings 233 adapted to attach to the rotatable member. In this embodiment, as in the embodiment of FIG. 4A-C, the hollow tube 231 may be ¼ inches in diameter, while the blunt edge has a width of ⅛ inches. The material enveloping the hollow tube 231 may be about 1/16 to 1/32 inches in width. The distance from the bottom of the hollow tube 231 to the bottom of the blunt edge 236 may be about 3/16 inches, although other dimensions can also be used. The cavity 235 may have a diameter of 1/16 inches, and may extend about 1.5 inches into the end of the lower portion 234. The side portion 243 may have a height of about ⅜ inches and a width of about ¼ inches. It is also noted that the blunt edge 236 may be offset relative to the hollow tube 231 to form a straight edge, as described in more detail in conjunction with FIGS. 12A-12B.

Furthermore, other configurations of the thin sealing device are also possible. FIGS. 12A-B show another embodiment of a thin sealing device 1230. As described above, the thin sealing device 1230 may include an upper portion 232, which is located above (i.e. further from the plane of the film than) the hollow tube 231. This upper portion 232 provides structural integrity for the device 1230 and also serves as the connection point to the pivotable member from which the thin sealing device 1230 is suspended, as described in more detail below. The upper portion 232 may also have one or more openings 233, which may be threaded, into which fasteners 653 (see FIG. 6), such as screws or bolts, can be inserted, which affix the upper portion 232 to the pivotable member 651.

This embodiment of the thin sealing device 1230 also has a lower portion 234. The lower portion is below (i.e. closer to the film than) the hollow tube 231. The lower portion contains a blunt edge 236 that contacts the film to heat, seal and cut it. As best seen in FIG. 12B, the cavity 235 is offset relative to the hollow tube 231, so that the device has a straight portion 1200, and an opposite curved or rounded portion 1201. This curved portion 1201 may be positioned on the side sealing mechanism such that it is oriented toward the actual mechanism and toward the film selvage. In other words, the straight portion 1200 is closest to the object to be wrapped.

Since the thin sealing device 1230 of FIG. 12A-B is asymmetric, it may be necessary to allow the flexibility to move the heating element (not shown) from one end of the hollow tube 231 to the opposite end of the hollow tube 231. FIG. 12A shows a side view of this embodiment, which includes two conduits 238a,b that pass from the top surface to the hollow tube 231. These conduits 238a,b may be threaded and used to capture set screw, which can be used to hold the heating element (not shown) in place in the hollow tube 231. In most embodiments, only one heating element is inserted into the hollow tube 231; however heating elements can be included on both ends of the hollow tube 231, if desired.

Similarly, two cavities 235a,b are included in this embodiment. In most embodiments, the thermocouple will be located in the cavity 235 closest to the heating element (not shown). For example, in one embodiment, the heating element (not shown) may be installed at the right side of hollow tube 231. It will be held in place using a set screw disposed in the conduit 238b in the right side of the device. The thermocouple is then installed in the cavity 235b on the right side as well.

The dimensions of the various components, conduits and cavities of the embodiment 1230 shown in FIGS. 12A-B may be similar to those described in connection with FIGS. 4A-C.

For example, the device 1230 may be about 6 inches long, and about ¼ inch wide. The sealing device 230 may have a height of about ¾ inches or more. Of course, other dimensions may also be used. In some embodiments, the hollow tube 231 has a diameter of about ¼ inches, although other dimensions can also be used. The material enveloping the hollow tube 231 may be about 1/16 to 1/32 inches in width. In some embodiments, the upper portion 232 has a width of about ¼ inches, although other dimensions are also possible. In the embodiment shown in FIG. 12B, the width of the upper portion 232 and the diameter of the hollow tube 231 are the same. However, other embodiments are possible where the width of the upper portion 232 may be greater or less than the diameter of the hollow tube. The distance from the top of the hollow tube 231 to the top surface of the thin sealing device 1230 may be about ⅜ inches, although other dimensions are also possible. The blunt edge 236 may have a radius of about 1/16 inches. The distance from the bottom of the hollow tube 231 to the bottom of the blunt edge 236 may be about 3/16 inches, although other dimensions can also be used. The cavity 235 may have a diameter of 1/16 inches, and may extend about 1.5 inches into each end of the lower portion 234.

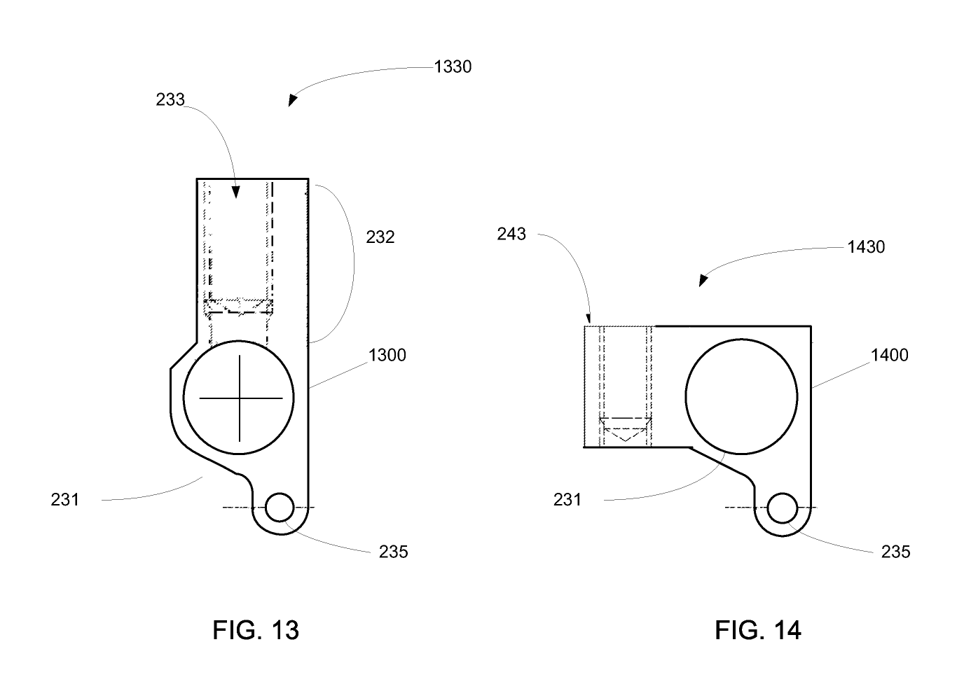

FIG. 13 shows yet another embodiment 1330, in which the upper portion 232 is also offset relative to the hollow tube 231 so as to create a straight edge 1300, which extends the height of the thin sealing device 1330. In this embodiment, the one or more openings 233, which affix the upper portion 232 to the pivotable member, may not be centered in the upper portion 232. Instead, the openings 233 may be aligned with the hollow tube 231, such that the openings 233 and the hollow tube 231 have horizontally aligned centers.

Again, the dimensions of the various components, conduits and cavities of the embodiment 1330 shown in FIG. 13 may be similar to those described in connection with FIGS. 4A-C.

FIG. 14 shows another embodiment 1430, which is similar to the embodiment of FIG. 11, where the upper portion is replaced with a side portion 243. In this embodiment, the cavity 235 is offset so as to create a straight edge 1400 along one side of the thin sealing device 1430, similar to FIGS. 12 and 13. Again, the dimensions of the various components, conduits and cavities of the embodiment 1430 shown in FIG. 14 may be similar to those described in connection with FIG. 11.

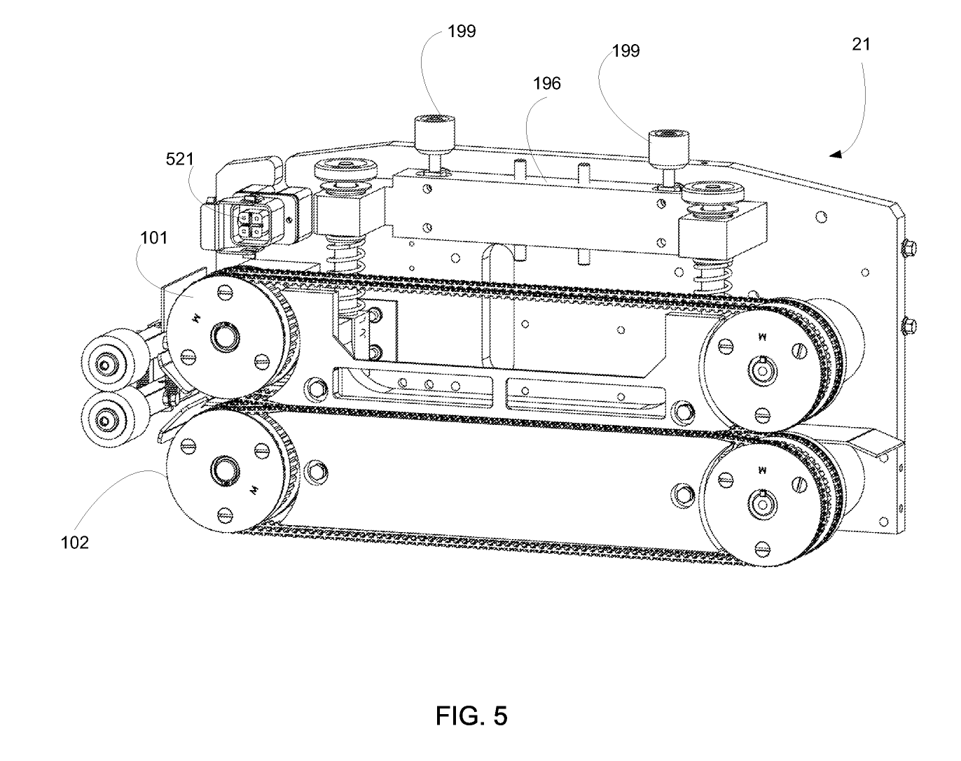

Any of these thin sealing devices may be attached to the side sealing mechanism 20 in a variety of ways. Although many of the figures, such as FIGS. 6-10, illustrate thin sealing device 230, the other embodiments 1230, 1330 may be used as well. In one embodiment, it is part of a removable assembly that attaches to a universal side mechanism. FIG. 5 shows the universal side mechanism 21, which is the side sealing mechanism 20 without a thin sealing device assembly installed. The universal side mechanism 21 includes two sets of cooperating pulleys, an upper set 101 and a lower set 102.

In addition, the universal side mechanism 21 has a mounting mechanism, designed to cooperate with a mounting mechanism on the thin sealing device assembly. In this embodiment, the mounting mechanism includes a mounting platform 196. A mounting bracket on the thin sealing device assembly is intended to rest on this mounting platform 196. In addition, in this embodiment, the connecting elements comprise two threaded thumb screws 199. To install a thin sealing device assembly, the thumb screws are unscrewed such that the mounting ports of the thin sealing device assembly can be slid in place. The thumb screws 199 are then replaced. The universal side mechanism 21 may also include the distal end of a power connector 521, which mates with a power connector on the thin sealing device 230. In addition, the universal side mechanism 21 may also include a receptacle for the feedback connector (not shown) and a receptacle for an air duct (not shown). In other embodiments, the various connectors may not be located on the universal side mechanism 21, and may instead originate at other locations on the side sealing machine 10. In other words, the side mechanism 21 may include pluggable connections for power, air, and feedback.

In other embodiments, the thin sealing device 230 may be rigidly attached to the side sealing mechanism 20, such that it is not readily removable. In such an embodiment, the mounting platform 196 and thumb screws 199 may be replaced with bolts or other fastening devices. In addition, the connections (such as air, power and feedback) may be implemented in a different manner. In other embodiments, the thumb screws 199 are replaced with captive spring loaded members.

The invention is not limited to any particular method of attaching the thin sealing device 230 to the side sealing mechanism 20.

FIG. 6 shows a front view of a modular heating/sealing/cutting assembly 600 using a thin sealing device. This thin sealing device assembly 600 may also be used with the universal side mechanism 21 shown in FIG. 5. The assembly 600 may have a thin sealing device 230, which is made of a metal. The thin sealing device 230 is heated through the application of power to a heating element contained in the hollow tube 231. This power may be a constant voltage and a variable current. In other embodiments, this power is a variable voltage. In yet other embodiments, a digital value is passed to the heating element, which represents the power to be used. The power from the sealing machine 10 passes to the heating element in the hollow tube via a power connector 633.

A platform 680 is suspended from mounting bracket 502, using extension brackets 630. As described above, mounting ports 501 are located on the mounting bracket 502. The length of extension brackets 630 is determined so that the thin sealing device 230 contacts the film when attached to the mounting platform 196 on the universal side mechanism 21 (see FIG. 5). As stated above, other methods of attaching the thin sealing device assembly 600 to the universal side mechanism 21 may also be used.

A pivotable member 651 is rotatably attached to the platform 680. In addition, an air cylinder 660 or other biasing member may be affixed to mounting bracket 502. The mounting bracket 502, extension brackets 630 and platform 680 remain fixed in position and do not rotate or pivot during normal operation.

The thin sealing device 230 is attached to the pivotable member 651. The pivotable member 651 may be fixed at one end, such as at pivot point 652 to the platform 680. The pivotable member 651 is attached to the thin sealing device 230 using one of more fasteners 653. These fasteners 653 may be attached to the openings 233 (see FIG. 4A). As described above, these openings 233 may be threaded, such that a screw or bolt may be affixed to these openings 233. In some embodiments, the fasteners 653 have “fins” to increase their surface area, thereby allowing more heat to escape to the air, rather than being transferred to the pivotable member 651. In some embodiments, the length and construction material of the fasteners is selected to limit the amount of heat that is transferred to the pivotable member 651. In some embodiments, the fasteners 653 are made of stainless steel, due to its strength and low thermal conductivity. In some embodiments, these fasteners are the only physical connection between the thin sealing device 230 and the rest of the side mechanism. Thus, heat generated by the heating element located in the hollow tube 231 of the thin sealing device 230 remains almost exclusively in the thin sealing device, and is not radiated to other components. Furthermore, the use of a thin sealing device having an upper portion adds support to the structure, making it more reliable in operation.

In some embodiments, the thin sealing device 230 may serve as the pivotable member 651. In other words, in these embodiments, the thin sealing device 230 is rotatably connected to the platform 680, without the use of a pivotable member 651.

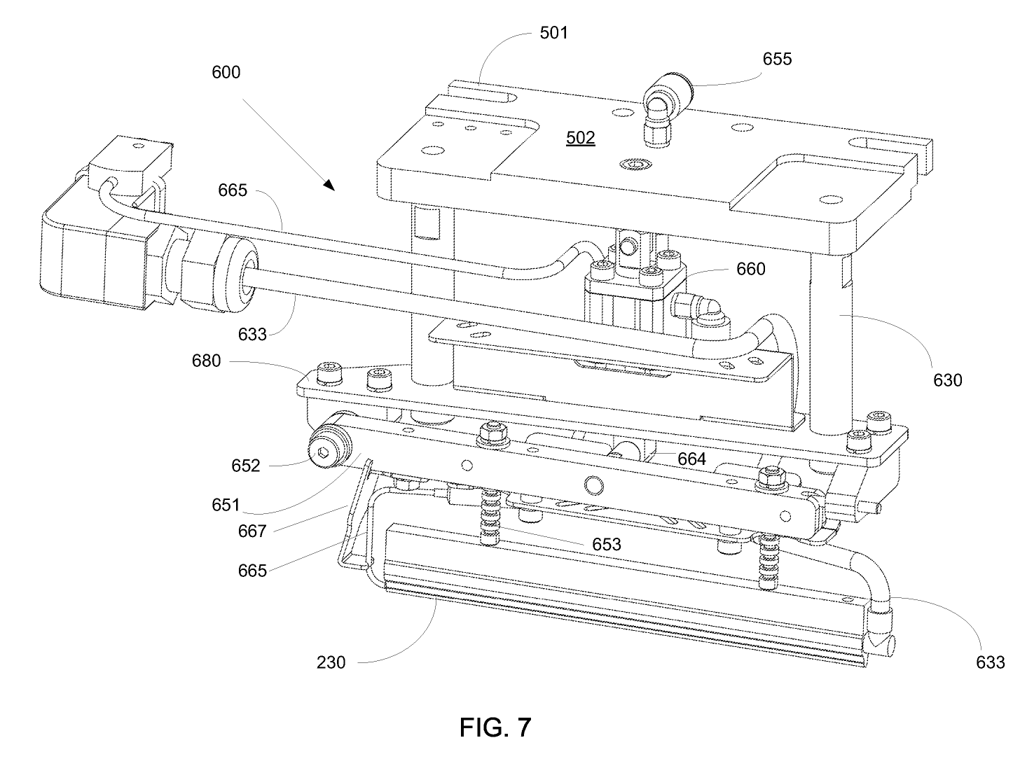

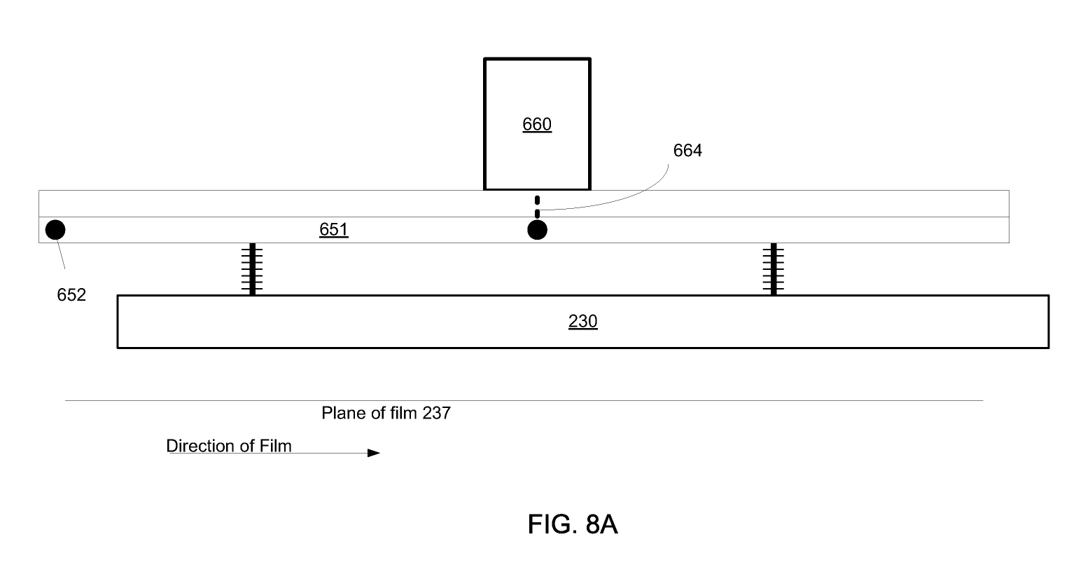

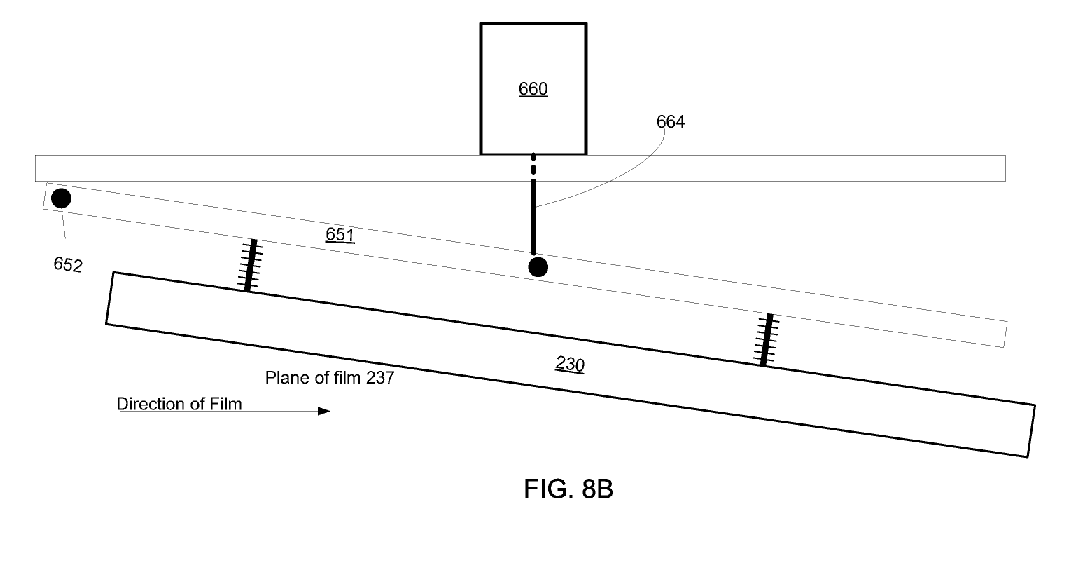

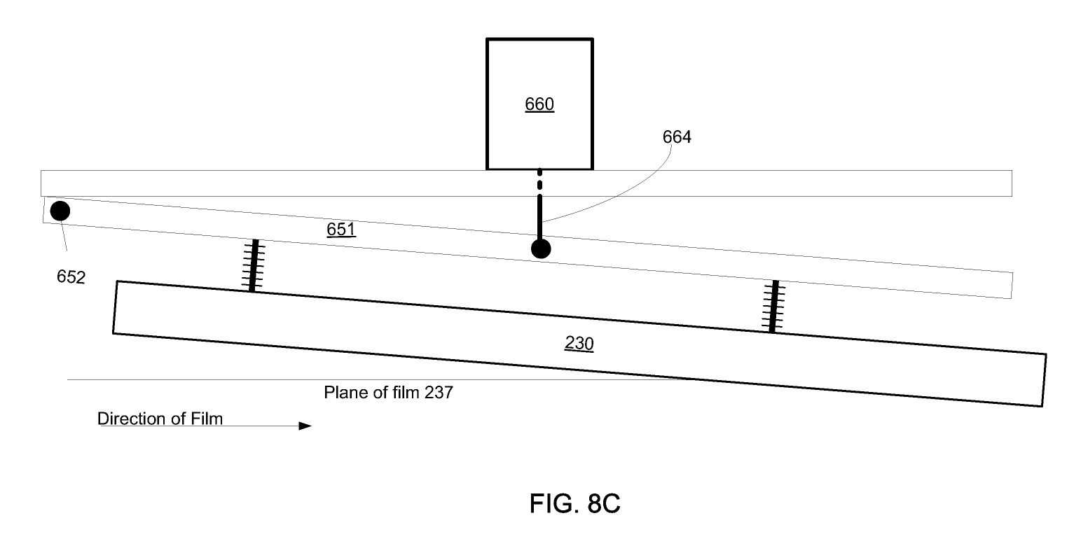

A wire 665 exits the thermocouple installed in the thin sealing device 230. In some embodiments, a bracket 667 may be used to hold this wire 665 in place. This wire 665 may attach to the feedback connector of the universal side mechanism 21. The pivotable member 651 is also attached to an air cylinder 660. The piston 664 (see FIG. 7) of the air cylinder is attached to the pivotable member 651. The air cylinder receives air from inlet 655, which, in some embodiments, may be located on top of mounting bracket 502. The air cylinder allows the pivotable member 651 to be pushed downward toward the film, or pulled upward away from the film. In one mode, there is no or little air in the air cylinder 660, and the thin sealing device 230 is in a stowed position. FIG. 8A shows the thin sealing device 230 element in the stowed position, where the device 230 is raised above the plane of the film 237.

Air can then be introduced to the air cylinder 660, so as to force the piston 664 to extend downward from the air cylinder 660, as shown in FIG. 7. The air cylinder 660 causes the rotatable member 651 and the thin sealing device 230 to pivot about the pivot point 652. This causes at least a portion of the thin sealing device to extend below the plane of the film 237. FIG. 8B shows one active position for the thin sealing device 230 where the device extends beneath the plane of the film 237.

Note that the angle of the pivot can change the portion of the thin sealing device 230 that crosses the plane of the film 237. For example, FIG. 8B shows a relatively long extension of the piston 664. This causes a portion of the thin sealing device 230 close to the leading edge to cross the plane of the film 237. FIG. 8C shows the piston 664 extended to a lesser degree. At this amount of extension, the portion of the thin sealing device 230 that cross the plane of the film 237 has changed, and moved toward the trailing edge. Thus, by varying the amount that the piston 664 is extended, the portion of the thin sealing device 230 that is exposed to the film can be modified. The extension of the piston 664 can be varied to change the portion of the sealing device 230 that contacts the film. This may increase the life of the sealing device, or increase the time between required maintenance or cleaning operations.

In one embodiment, the air cylinder 660 is an adjustable stroke air cylinder. In this embodiment, the amount of extension, or stroke, allowed by the piston 664 is limited by an adjustable mechanical stop. Thus, the portion of the thin sealing device 230 which is intended to contact the film can be changed by adjusting the mechanical stop. In another embodiment, a cylinder having multiple stop positions may be used, thereby allowing different portions of the thin sealing device 230 to contact the film.

The above description relates to an air cylinder that is configured to be in the stowed position in the absence of applied air. However, other air cylinders may be used which are in the operative position in the absence of air. In these embodiments, air is introduced to move the heating element to the stowed position. Air is then removed to move the heating element to contact the film.

The above embodiment discloses a thin sealing device 230 that is affixed to a pivotable member 651 having a pivotable leading edge, with a biasing member causing the trailing edge to move. However, in other embodiments, the leading edge may be attached to the biasing element, while the trailing edge is pivotable. In another embodiment, the pivot point may be located between the leading edge and trailing edge.

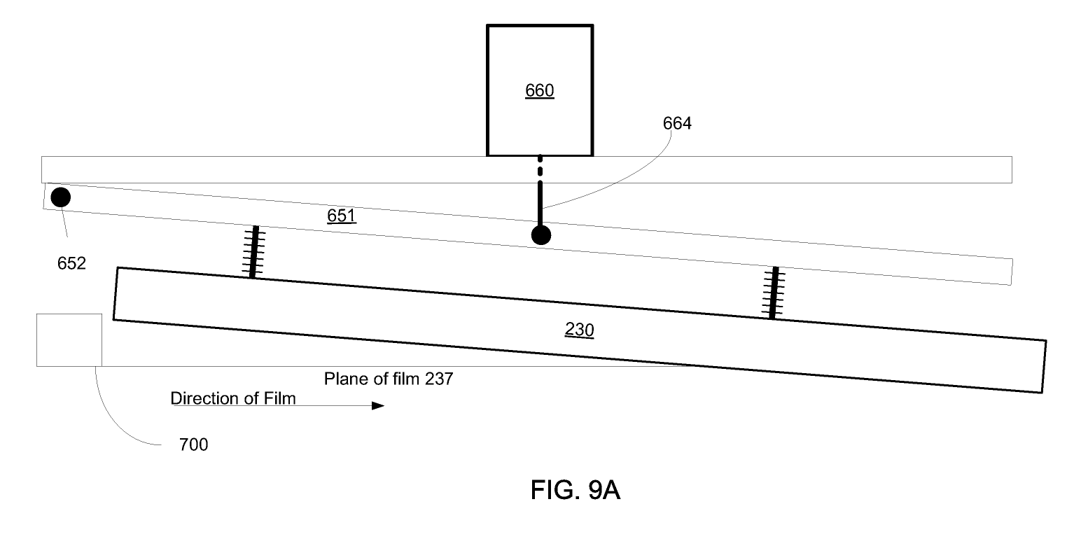

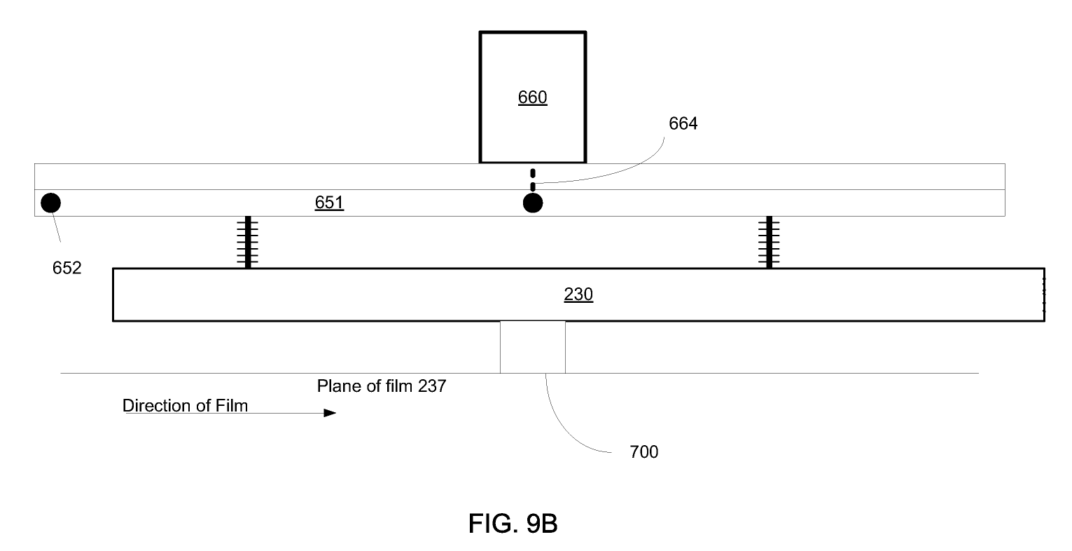

The use of an air cylinder 660 has other benefits as well. For example, the piston 664 is extended due to the force of the compressed air within the cylinder 660. The force exerted by the air on the piston 664 is not infinite, and can be overcome by an opposing force. For example, FIG. 9A shows the thin sealing device 230 in the position shown in FIG. 8C. However, a foreign material 700 is positioned on the film in the path of the thin sealing device 230. As described above, with rigidly mounted heating elements, the foreign material may potentially damage the leading edge of the thin sealing device 230. However, in this embodiment, the force exerted by the foreign material 700 on the thin sealing device is sufficient to overcome the force of the compressed air within the air cylinder 660. This then causes the piston 664 to retract from its extended position, and allow the thin sealing device 230 to be forced to its stowed position, as shown in FIG. 9B.

Thus, the use of an air cylinder 660 and a rotatable pivot at or near the leading edge of the thin sealing device 230 allows many benefits currently not possible. This air cylinder 660 allows the use of at least two different positions, an operational position (such as FIG. 8B and FIG. 8C) and a stowed position (FIG. 8A). In addition, the air cylinder 660 allows the possibility to adjust the angle of the thin sealing device, and therefore, the portion of the thin sealing device that contacts the film. Finally, the air cylinder 660 also allows the thin sealing device 230 to automatically move out of the plane of the film, if confronted with a foreign material, in the path of the device.

Furthermore, the use of an air cylinder 660 allows the movement of the thin sealing device 230 to be controlled automatically. For example, the side sealing machine 10 may include a controller. The controller consists of a processing unit, such as a microprocessor, PLC, embedded processor or other suitable device. The controller also includes a memory element adapted to store the instructions that are executed by the processing unit. In addition, the memory element may contain volatile data as required. The memory element may be a semiconductor memory device, such as RAM, EEPROM, FLASH ROM, DRAM or other technologies. It may also include magnetic or optical storage, such as disk drives, CDROMs, or DVDs. In one embodiment, the controller can be programmed to introduce air to the air cylinder prior to starting the pulleys, and programmed to draw air from the air cylinder when sealing is stopped or paused. Thus, the controller can control the position of the thin sealing device relative to the plane of the film prior to, during and after a sealing operation. In addition, in some embodiments, the controller may control the position of the thin sealing device based on the type or thickness of the film being used.

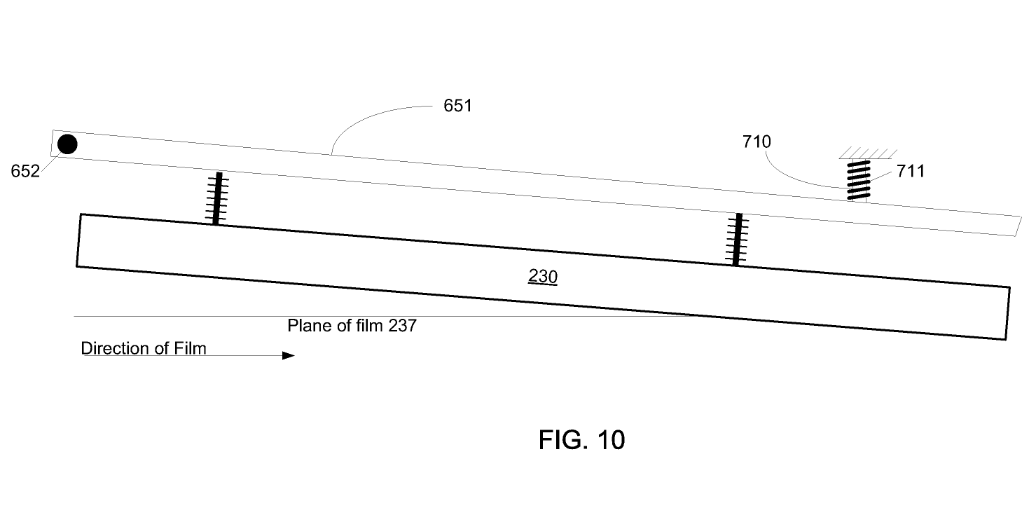

While the air cylinder 660 offers these many benefits, in another embodiment, the only goal may be to create a mechanism that allows the thin sealing device to move out of the plane of the film when confronted with a foreign material. In this case, as described above, the air cylinder 660 may be used. However, other embodiments are also possible. For example, the air cylinder may be replaced with an extendable piston 710, which is biased downward with a spring 711 or other biasing member, as shown in FIG. 10. In this embodiment, the foreign material would push against the downward force of the spring 771 or other biasing member and cause the thin sealing device 230 to rotate so as to be above the plane of the film 237. This allows the foreign material to pass under the thin sealing device 230, without causing any damage to that element. In addition, any suitable biasing member may be used. For example, an electronic solenoid may also be used.

While the present disclosure describes the use of air cylinders and other biasing members with thin sealing devices, the disclosure is not limited to this embodiment. For example, other heating/cutting/sealing devices, such as heated blades or hot wires may also benefit from the use of biasing members to allow movement relative to the plane of the film.

The controller described above may also be used to control the temperature of the thin sealing device 230. For example, the controller may receive feedback from the thermocouple, where the value returned is related to the temperature measured by the thermocouple. Based on this, the controller may adjust the voltage (or current) being supplied to the heating element, so as to maintain the thin sealing device 230 at a predetermined temperature. The controller may use any type of control, including closed loop control. The controller may utilize a PID loop to maintain the temperature of the thin sealing device 230, or may use a simpler variation thereof.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. An apparatus for sealing a film, comprising:
a sealing device comprising:
an upper portion for attachment to a sealing machine;
a hollow tube through at least a portion of said device, said hollow tube located below said upper portion; and
a lower portion located below said hollow tube, said lower portion having a blunt edge for contacting, heating, cutting and sealing said film; and
a heating element disposed in said hollow tube.

2. The apparatus of claim 1, wherein said blunt edge has a cross-sectional width and said cross-sectional width is less than a diameter of said hollow tube.

3. The apparatus of claim 1, wherein said lower portion comprises a cavity, and comprising a thermocouple disposed in said cavity.

4. The apparatus of claim 1, wherein said heating element comprises an internal thermocouple.

5. The apparatus of claim 1, wherein said upper portion comprises conduits for attachment to one or more fasteners, said fasteners connecting said sealing device to said sealing machine.

6. A side sealing machine for sealing a film, comprising:
a rotatable member, attached to said side sealing machine at a pivot point;
a sealing device comprising:
an upper portion for attachment to said rotatable member;
a hollow tube through at least a portion of said device, said hollow tube located below said upper portion; and
a lower portion located below said hollow tube, said lower portion having a blunt edge for contacting, heating, cutting and sealing said film;
a heating element disposed in said hollow tube; and
a biasing member in communication with said sealing device, which in one position, urges a trailing portion of said sealing member downward toward a plane of said film.

7. The side sealing machine of claim 6, wherein said biasing member comprises an air cylinder.

8. The side sealing machine of claim 7, wherein said air cylinder, when not filled with air, has a second stowed position in which said sealing device is retracted to a level above said plane of said film.

9. The side sealing machine of claim 7, wherein said air cylinder comprises a extendable piston having a plurality of stroke lengths, such that said sealing device may be rotated at a plurality of angles.

10. The side sealing machine of claim 6, wherein said biasing member comprises a spring.

11. The side sealing machine of claim 6, wherein said biasing member comprises an electronic solenoid.

12. The side sealing machine of claim 6, wherein said biasing member is biased with a force sufficiently small so as to be overcome by a foreign material located on said film in the path of said sealing device, so that said foreign material causes said sealing device to rotate to a position where said sealing device is at a level above said plane of said film.

13. The side sealing machine of claim 7, further comprising a controller, configured to introduce air into said air cylinder.

14. The side sealing machine of claim 6, wherein said upper portion comprises conduits for attachment to one or more fasteners, said fasteners connecting said sealing device to said rotatable member.

15. The side sealing machine of claim 6, wherein said blunt edge has a cross-sectional width and said width is less than a diameter of said hollow tube.

16. The side sealing machine of claim 6, wherein said lower portion comprises a cavity, further comprising a thermocouple disposed in said cavity.

17. The side sealing machine of claim 7, wherein said air cylinder comprises an extendable piston, said piston connected to said rotatable member.

18. The side sealing machine of claim 6, further comprising a thermocouple located near said blunt edge and a controller, wherein said controller receives feedback from said thermocouple and controls said heating element using closed loop control.

19. An apparatus for sealing a film, comprising:
a sealing device comprising:
a side portion for attachment to a side sealing machine;
a hollow tube through at least a portion of said device, said hollow tube located adjacent to said side portion; and
a lower portion located below said hollow tube, said lower portion having a blunt edge for contacting, heating, cutting and sealing said film; and
a heating element disposed in said hollow tube.

20. The apparatus of claim 19, wherein said blunt edge has a cross-sectional width and said cross-sectional width is less than a diameter of said hollow tube.
